(19) United States
(12) Patent Application Publication
(10) Pub. No.: US 2004/0064373 A1
(43) Pub. Date: Apr. 1, 2004

(54) Point of sale receipt service

(76) Inventor: Robert W. J. Shannon, Wellington (NZ)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(21) Appl. No.: 10/262,641

(22) Filed: Sep. 30, 2002

(51) Int. Cl. G06F 17/60

(52) U.S. Cl. 705/24

(57) ABSTRACT

A system and method for providing a receipt for a transaction involving electronic payment includes accessing electronic point of sale transaction data, generating a receipt in text format from the transaction data, storing the generated receipt in an indexed database, and making the receipt accessible via one or more electronic communications networks. In an exemplary embodiment, the receipt can be accessed subsequent to the transaction at any time via an ATM, or other electronic banking network or via the Internet from a bank web portal, and viewed, emailed, stored and/or printed out as may be desired. In an exemplary embodiment, the receipt comprises an ASCII text file that can be transmission quickly even at low data transfer rates and has a low storage cost.

### TECHNICAL FIELD

The present invention relates to electronic payment processing, and more particularly to a method and system for electronically capturing, storing and making available for subsequent access, receipts for transactions involving electronic payment.

### BACKGROUND INFORMATION

People use point-of-sale (“POS”) electronic payment processing services for purchasing a wide variety of goods and services. These POS services include, for example, a facility that can issue a receipt of the transaction. Whether a customer decides to accept a receipt, decline a receipt, or accepts a receipt and then loses the receipt, a receipt is nonetheless generated electronically at the point-of-sale. If a customer subsequently has a dispute with the merchant regarding the goods or services, such as, e.g., a desire to return damaged goods, or a desire to return goods that do not fit or were not appropriate, the customer often is required to present proof of purchase at the time the receipt is requested. In a transaction involving some form of electronic payment, the receipt issued at the point of sale is generally the only form of evidence of the purchase that identifies the particulars of the transaction. Many times, even if a physical receipt is retained by the customer at the point of purchase, it cannot be found when subsequently required as evidence of the purchase when needed to return or exchange the goods.

Further, there are numerous other reasons why people require receipts for purchases they have made. Those reasons are often not immediately apparent at the time of the purchase and therefore purchasers are not careful to diligently organize, store and re-access their receipts when they need them. Such reasons include, for example, the necessity of corroborating expense accounts submitted to an employer, the necessity of substantiating reimbursements from nontaxed benefits accounts maintained by an employer, or the necessity, in the event of audit by a taxing authority, to recreate expenses and substantiate deductions and claimed accounting. To date, there is no easy solution for relieving the individual consumer with the burden of storing, filing, and indexing for subsequent retrieval, the multitude of receipts that he or she acquires in the course of day to day life that involve electronic payment transactions.

Equipment intensive and storage intensive approaches exist for storing some data associated with conventional electronic payment transactions. For example, U.S. Pat. No. 6,397,194 B1 to Houvener et al (“Houvener”) purports to remedy the problem of customer signed transaction receipt retention and accessibility for merchants by providing a scanner at a POS location. According to Houvener, a scanner is configured to scan a transaction document, such as a credit card transaction receipt with a customer's signature. The scanned transaction documents are then maintained in a transaction data record database. Houvener is explicitly addressed to a problem that a merchant encounters when a customer of that merchant disputes a charge. Houvener notes that although merchants endeavor to retain proof of all charges, they process they often lose a significant percentage which makes it difficult for the merchant to successfully defend against a disputed item, often resulting in the merchant forfeiting payment. Houvener purports to solve this problem by allowing the merchant to readily access, by either a manual request or a telephone request to the banking network operators, or in alternative embodiments, via an enhancement to the POS terminal allowing the merchant to download it, a digitized image of the signed receipt.

While Houvener attempts to solve the merchant's quandary when a credit card company issues a request for copy/proof of a disputed charge which the merchant has lost, it does not solve the above-described problem of consumers who need to easily access to each and every one of their receipts for their various transactions. Moreover, Houvener creates a significant storage and transmission problem resulting from the creation and storage of digitized copies of a multitude of documents, which requires storing files in some type of image file format. Such image file formats are large, often in the range of 12 Kb to store as a .GIF file, 11 Kb to store as a .JPG file, 101 Kb to store as a .TIF file, and 101 Kb to store as a .BMP file, even though the image only includes an average of about twenty short lines of text for an average receipt plus the digitized signature. For any more than a trivial number of system users and receipts stored per user, such a solution is wholly impractical with regard to (i) storage capacity on any electronic network and associated archive, and (ii) transmission bandwidth required to effectively transfer such image files over an electronic network as required by users of the network. As mentioned above, transmitting bulky image files over a communications network, even a state of the art network, is time consuming, as anybody who has ever attempted to download a JPG, JIF, or TIF file from the Internet using the ubiquitous dial-up modem on their home PC has experienced. Additionally, besides the prohibitive storage requirements and costs associated therewith, the Houvener approach requires expensive scanning equipment to be added to each and every existing POS terminal.

In sum, although technology has made non-cash forms of purchasing common and easy to use, such that there is a built-out infrastructure which has debit and credit card availability at the corner grocery store, at the neighborhood gas station, at the post office and even at the local courthouse for paying parking tickets, human nature has not made the required corollary advance, and people tend to lose the receipts associated with these transactions. What is needed in the art is a method and system of creating electronic versions of all the receipts that a person utilizing electronic payments can amass, storing them economically, and in such a manner that they can be easily retrieved.

### SUMMARY OF THE INVENTION

A method and system are presented for providing an electronic receipt for a transaction involving electronic payment. The method includes accessing electronic point of sale transaction data, generating a receipt in text format from the transaction data, storing the generated receipt in an indexed database, and making the receipt accessible via one or more electronic communications networks. In an exemplary embodiment of the present invention, the receipt can be accessed by a system user subsequent to the transaction at any time, via, for example, a conventional ATM network, via a bank teller at the user's bank, or via the Internet from a system web portal, and viewed, emailed, stored and/or printed, as may be desired. In a preferred embodiment the receipt comprises less than 500 bytes of data and thus can be transmitted quickly even at low data transfer rates, and has a low storage cost.

### BRIEF DESCRIPTION OF THE DRAWINGS

FIG. 1. is an exemplary process flow diagram of an exemplary retail transaction utilizing electronic payment according to an embodiment of the present invention;

FIG. 2 is an exemplary process flow diagram of a system according to an embodiment of the present invention;

FIG. 3 is an exemplary process flow diagram of a receipt generation function according to an embodiment of the present invention;

FIG. 4 is an exemplary process flow diagram illustrating a user accessing receipts according to an embodiment of the present invention;

FIG. 5 is an exemplary subprocess flow diagram of a receipt request depicted in FIG. 3 according to an embodiment of the present invention;

FIG. 6 is an exemplary receipt format according to an embodiment of the present invention;

FIG. 7 is an alternative exemplary receipt format according to an embodiment of the present invention; and

FIG. 8 is an exemplary modular software diagram according to an embodiment of the present invention

### DETAILED DESCRIPTION

Exemplary embodiments of the present invention relate to a system and method for electronically generating, storing, indexing and providing access to receipts for transactions involving electronic payment. A common example of such a transaction, used herein for illustrative purposes, is that of a consumer transaction where payment is made via a conventional debit card, check card or credit card. In such exemplary transactions, a customer desires to purchase a good or service from a retail establishment, and pays for the purchase with either a credit card, check card, or debit card. Commonly, such a credit or debit transaction is finalized at the point of sale (“POS”) by either the customer and/or an employee of the retail merchant utilizing an electronic POS terminal. A particular example of such a purchase, used herein for ease of illustration purposes, is that of a customer making a purchase in a retail outlet, as shall be described below. As will be appreciated by those skilled in the art, other suitable examples include electronic funds transfer transactions at retail establishments in the United States or any other country where such electronic funds transfer methods are supported.

For purposes of illustration of the operation of the system and method according to an exemplary embodiment of the present invention, it is assumed that the exemplary customer enters a retail coffee shop, purchases a coffee and a sweet roll, and incurs a total bill of $10.85. It is further assumed that the exemplary customer wishes to pay this bill utilizing electronic payment, for example by debiting a savings account using a debit card issued by the customer's bank. It is further assumed that the customer does not desire to take any additional cash out of the account. While the retail outlet provides the customer a receipt, it is the unfortunate experience of the customer that the receipt is misplaced. Thus, according to the system and method of the present invention, in addition to the physical receipt provided by the barista, an electronic copy of the receipt is generated ancillary to the processing of the transaction by the customer's bank.

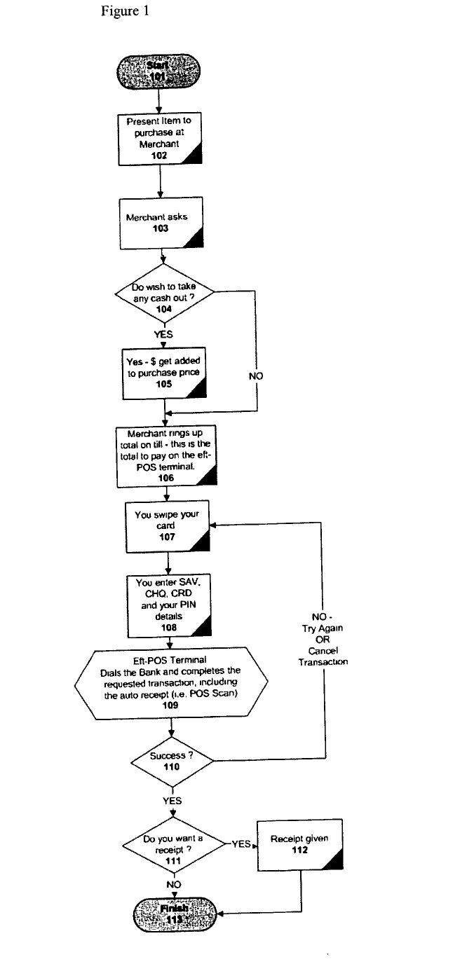

FIG. 1 illustrates the process flow of an exemplary conventional purchase transaction as it might occur in the retail outlet coffee shop in our illustrative example. At 101, the process flow begins with the exemplary customer choosing an item to purchase. In the context of our illustrative example this could include ordering a coffee or tea-based drink and perhaps an additional sweet roll or the equivalent from the barista. At 102, the items desired to be purchased are presented to the merchant, in our example the coffee shop barista, and at 103 and 104, the merchant queries the customer whether the customer wishes to have cash, in addition to the purchase price of the chosen articles, withdrawn from the customer's bank account. At 105, if the customer answers affirmatively, the dollar amount that the customer specifies is added to the purchase price. On the other hand, if the customer answers negatively, 105 is bypassed and the process flow moves to 106. At 106, the merchant rings up the total on the till, which is the total to be paid via electronic payment processing. In our example case of the retail outlet coffee shop, this transaction is effectuated using, e.g., an eft-POS terminal (a popular electronic point-of-sale terminal in New Zealand; for further information see http://www.eftpos.co.nz).

At 107, the customer swipes a bank card in the area provided on a POS terminal and at 108 enters the type of account (e.g., savings, checking, or credit), and a Personal Identification Number or PIN. At 109, the POS terminal, either via dial-up connection or dedicated data network connection, contacts the bank where the customer has their designated account and completes the requested transaction, including creation of the data necessary for the electronic receipt, as shall be more fully described below. At 110, if the information provided by the customer is acceptable, the payment transaction is successful. If not, the process flow returns once again to 107 where the customer's card must again be swiped, or the transaction canceled. Assuming a successful transaction, the process flow moves to 111, where the customer is queried whether they want a receipt. If they answer affirmatively the process flow moves to 112 and a physical receipt is given; if they answer negatively the process flow terminates at 113.

As described above, even if a customer obtains a receipt, and with all good intentions intends to properly file the receipt so that it can be easily accessed in the future, experience dictates to those skilled in the art that a significant percentage of the time even the best-intentioned receipt keepers will lose a significant number of their receipts. Some people, as is known to those skilled in the art, are simply incapable of preserving any receipt more than the one or two days during which, for example, it sits on the floor of their car or is misfiled in the back of their checkbook.

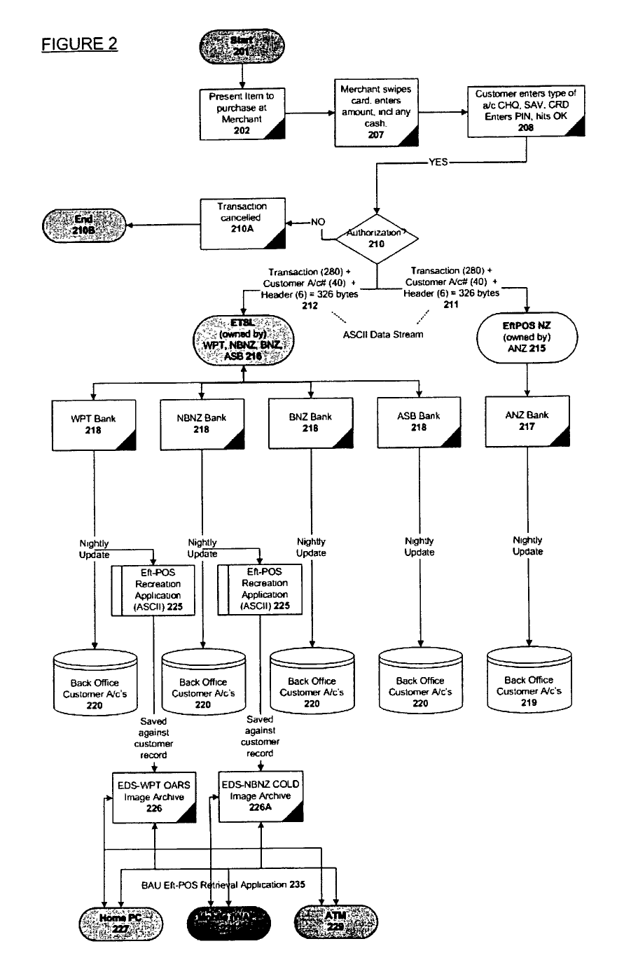

FIG. 2 depicts an exemplary process flow and system level diagram according to an embodiment of the present invention. The example depicted in FIG. 2 uses the details of the illustrative example described above.

With reference to FIG. 2, the process flow begins at 201. At 202, a customer presents an item for purchase at a merchant, and at 207 the merchant swipes the purchaser's card, and enters the amount of the purchase including any additional cash. The process continues at 208, where the customer enters the type of account, such as a checking, savings, or credit card account, and also enters a PIN and presses an OK or Enter button to have the transaction sent to an electronic data communications network. Such electronic data communications network can be of any type known or to be known in the art, such as, for example, an electronic data network dedicated to facilitating credit card, debit card and checking card verifications, authorizations and electronic payments. Such networks are often set up in the banking industry or other related fields to interface between merchants accepting electronic payment methods and the banks or other financial institutions offering credit, debit, check and other similar cards, and thus effectuate electronic payments. Such networks shall be referred to herein as “banking networks.”

The merchant accepting electronic payments generally has a terminal, termed a point-of-sale or “POS” terminal, which contains a card reader. The card reader is capable of, for example, reading the information stored on the magnetic strip of the transaction card. Accordingly, care must be taken in inserting the transaction card since the magnetic reader will often expect the magnetic strip to be disposed in a predetermined orientation. Upon insertion of the transaction card into the magnetic reader, the POS terminal verifies an individual's access to the account encoded thereon. This is accomplished by, for example, entering the preassigned PIN by means of the keypad. The transaction card is typically constructed of plastic, such as a conventional magnetic strip debit card or credit card. The transaction card includes, for example, a front surface and a rear surface. Along the front surface there is often displayed an account number identifying the account to which the transaction card is associated. The name of the individual to whom the account belongs may also be provided on the front surface. Front surface or rear surface also may include a logo of the service provider or other form of branding.

The rear surface of the transaction card contains, for example, a magnetic strip on which information pertaining to the account is stored. This information often includes the account number and routing code of the financial institution or organization issuing the transaction card. The rear surface may further include various information, illustrated by the numeral, pertaining to the operation of the transaction card.

Upon the transaction card being read by the POS terminal and the user's authorized access verified, the POS terminal transmits information regarding the proposed transaction via the banking network to the customer's bank seeking authorization for the transaction. Again with reference to FIG. 2, at 210 the customer's bank, via the banking network, either communicates a yes or no as to whether the proposed transaction is authorized. If the answer is yes the flow proceeds (downward in FIG. 2) as shall be next described. If the authorization query is returned as no, the transaction is canceled at 210A and the process flow ends at 210B. Such communications and processing of electronic transactions, including the approval of or disapproval of such transactions, are well known in the art.

Assuming that the authorization to the 210 query is yes, flow continues to 215 and 216, where data passes to a banking network available to merchants in the area of the retail outlet, e.g., ETSL and EftPOS in New Zealand. As is known in the art, the data transmitted to these networks, as can be seen at 211 and 212, is, for example, a text format data stream (e.g., ASCII) containing details from the transaction carried out at 202, 207, and 208. The data included in the transaction data provided by POS terminal and sent via the banking network includes, for example, 280 bytes of transaction details, 40 bytes for a customer account number, and a 6 byte header, for a total, in this exemplary embodiment, of 326 bytes. At 215 and 216, this data is respectively transmitted to the banking networks, e.g., EftPOS NZ and ETSL. Each of these banking networks services one or more banks, and generally a given POS terminal can access any banking network, thus allowing any bank card to be used at any merchant. For example, in the case of electronic transfer networks in New Zealand, EftPOS NZ is owned by and services Australia New Zealand Bank (“ANZ Bank”), and ETSL is owned by and services the consortium of Westpac Trust Bank (“WPT Bank”), The National Bank of New Zealand (“NBNZ Bank”), The Bank of New Zealand (“BNZ”), and The Auckland Savings Bank (“ASB”). Similar arrangements for electronic financial transactions are provided by similar electronic funds transfer networks in other countries, including the United States, and are well known in the art.

At 215 and 216, respectively, the process flow moves to 217 and 218, which involve data flowing from the data network to the customer's bank. In the depicted example, 217 involves data flow from, for example, EftPOS to ANZ Bank, and 218 involves data flow from ETSL to WPT, NBNZ, BNZ and ASB. The example of FIG. 2 depicts two of the ETSL banks using the method of the present invention, i.e., WPT Bank and NBNZ Bank, and two that are not utilizing the method of the present invention, i.e., BNZ and ASB, indicated by data being processed at 225 according to an embodiment of the present invention only for WPT Bank and NBNZ Bank. The process flow moves immediately from 218 to 220 wherein, for example, at a nightly update, the data from all of the relevant transactions, such as those depicted at 202, 207, and 208, are posted to customer accounts respectively maintained in a bank's back office processing. It is noted that such back office processing can be in-house in a particular bank or financial entity, or as is known in the art, can be contracted out to enterprises who specialize in maintaining back office services for financial institutions, such as data processing services provided by Electronic Data Systems of Plano, Tex. At 220, the information transmitted in the ASCII data stream from the merchant POS terminal through banking networks 216 and 215 is stored. A similar state of affairs prevails at the depicted ANZ Bank 217, and its back office storage area 219.

All the data for each merchant transaction is included in a predetermined format on the electronic banking network and maintained on the network and/or at the customer's bank for defined periods of time. The transaction data, however, is in no way indexed for easy retrieval by a particular customer. Moreover, beyond a given short term backup storage period, and the guidelines for a particular financial network, not all of the transaction data sent by a merchant POS terminal to a customer bank will always be saved. The POS generated data is used to update customer accounts in a conventional manner as is known in the art. Thus, POS transaction data such as a merchant number, a POS terminal number and a transaction number may not necessarily be posted to a customer account at the customer's bank (as opposed to critical information such as the time and date of a transaction, the amount debited/credited, and the merchant name and address) and thus not saved by a customer's bank.

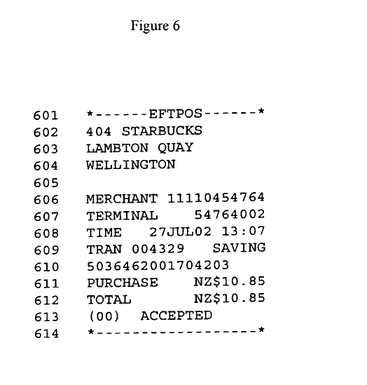

At the two example banks depicted as using the method according to an exemplary embodiment of the present invention in FIG. 2, at 225 the nightly update data streams are accessed, from which the 326 bytes of data sent in 212 necessary to compile a receipt (according to the example form of receipt depicted in FIG. 6) are extracted and saved in a text-type receipt format with respect to each customer's record. Pseudocode is provided below illustrating an exemplary implementation of the receipt creation process according to an embodiment of the present invention. As can be seen therefrom, the receipt is created by extracting all of the POS transaction data which is transmitted over the banking network, and formatting it in a manner which when printed substantially imitates the actual POS receipt.

In the depicted example of FIG. 2, the receipt is saved to a storage medium, such as a relational database or other suitable storage facility identified in FIG. 2 as the “EDS-WPT OARS Image Archive” 226 and the “EDS-NBNZ COLD Image Archive” 226A. The titles used for the storage media herein are merely illustrative of particular exemplary embodiments of the present invention. As noted above, the receipts stored at 226 or 226A, when printed, appears as being substantially similar, if not identical to, the original receipt issued by the merchant POS terminal at the time the transaction was initiated.

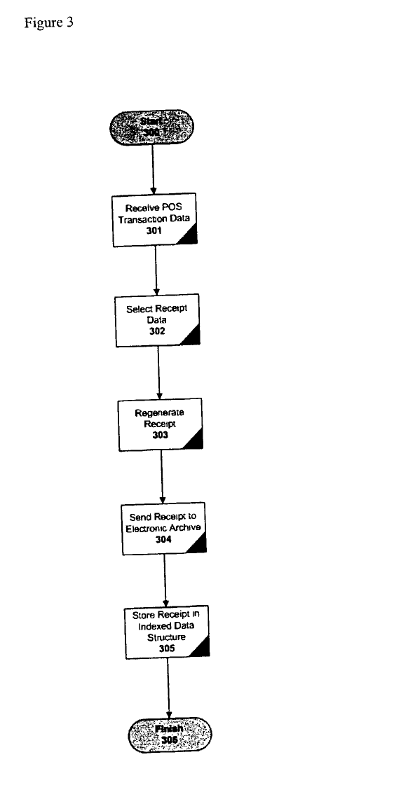

As is known in the art, the “EDS-WPT OARS Image Archive” 226 and the “EDS-NBNZ COLD Image Archive” 226A are examples of bank archiving systems provided by Electronic Data Systems of Plano, Texas where customer statements or the like are stored. These archives are generally used to store digital images of customer monthly statements. These archiving systems replace the former banking practice of maintaining physical copies of every printed customer monthly statement, and thus save on bank storage and filing overhead. Given such archiving systems, if and when a customer makes a request for a copy of a past monthly statement, such copy can be easily and quickly generated from the digital image of the original, significantly decreasing the response time by the banks to such customer needs. The example archives 226 and 226A, could be, for example, the actual archives currently used by WPT and NBNZ banks, respectively, which are operated by Electronic Data Systems NZ Ltd. Any equivalent third party or in-house archiving or data storage system can alternatively be used, as is or may be known in the art. Further details regarding creation of the receipts stored in archives 226 and 226A are provided with regard to FIG. 3 below.

Within the archives 226 and 226A, the stored POS receipts can be, for example, associated or tagged to the customer's record of monthly statement archives. This allows easy access by the bank's computers to all of the customer's data and decreases access times when a customer, for example, goes online, and first makes a request for a copy of a past monthly statement, and next requests a search for and print out (or download) of a number of his or her POS receipts. Alternatively, a separate database of POS receipts could be maintained, as may be convenient in a given business context. Inasmuch as the stored POS receipts are indexed by customer, they are easily accessed. Such customer access is depicted at 227 through 229 as shall be next described.

By means of a retrieval application 235, which, for example, can be any program interfacing the image archives 226 and 226A to a PC 227, a mobile device (PDA, cell phone, or the like operating using some wireless network protocol as is known in the art) 228 or an Automated Teller Machine (“ATM”) 229, as are known in the art, a customer may obtain any stored regenerated receipt. For example, the receipt could be accessed by a customer using a PC to access the customer's bank's web page or through the various on-line banking menus call up a receipt and either store it on his or her local PC, email it to a place of his or her choice or, or print it at a local printer. A similar functionality could be used at the mobile device 228 and the ATM 229.

What will next be described are some of the processes depicted in FIG. 2 in greater detail.

FIG. 3 depicts an exemplary process flow diagram for the receipt generation and storage functionalities according to an embodiment of the present invention. Receipt generation and storage according to an embodiment of the present invention provides significant benefits over the existing art and further avoids a need for a significant hardware/software upgrade at the literally millions of POS terminals currently in use for implementation. To this end, the processing to generate and store the electronic receipt according to an embodiment of the present invention is done, for example, not on the merchant side of the banking network but rather on the customer's bank's side of the banking network.

In the illustrative example presented above (and depicted in FIG. 2), such banking network provider could be ETSL (for information see http://www.etsl.co.nz) or EftPOS NZ (for information see http://www.eftpos.co.nz), and such customer banks are, for example, WPT, NBNZ, BNZ, ASB and ANZ Banks. Similarly, financial networks in the United Statesand elsewhere in the world providing ATM, credit, and debit POS capabilities also could be an exemplary network provided in accordance with an exemplary embodiment of the present invention. When an electronic payment transaction occurs, the transaction data ends up at the customer's bank. Accordingly, the transaction data stored by the customer's bank or the banking network can be accessed to generate the electronic receipt according to an embodiment of the present invention. In other exemplary embodiments of the present invention, the transaction data stream could be accessed at any point in its path and the receipt regenerated therefrom, including even at the merchant POS, within the banking network, etc. as economics and business conditions may dictate. Once the receipt is generated, whether done at the banking network or elsewhere, it wood be sent to a storage device, for example, the receipt archive for indexed storage.

Thus, beginning at 301 shown in FIG. 3, the customer's bank receives the point-of-sale transaction data from the merchant. This generally occurs in nightly batch processing at the customer's bank which posts all debits to customers' accounts resulting from the various merchants with whom the bank's customers have dealt that day and includes the known transaction data provided in such banking systems. Alternatively, the data could be provided at any convenient periodic interval.

At 302, a computer program, for example, as implemented in software, extracts the necessary data from the aggregate transaction record of that day needed to create an electronic receipt according to an exemplary embodiment of the present invention. Preferably, the receipt is formatted, for example, in the same manner as is the physical receipt given by the POS terminal (as indicated at 112 in FIG. 1), from the transaction information and thus regenerates the receipt in 303. Because the electronic receipt so generated according to an embodiment of the present invention has the same appearance as other forms of receipt dispensed at the POS, it should be completely acceptable as proof of purchase to a merchant.

Since at 303 the electronic receipt is recreated and sent to an archive only upon reaching the customer's bank (such as, e.g., National Bank of New Zealand or Westpac Trust Bank, in the illustrative example discussed above), there are no changes required at the point of entry of the transaction, i.e., at the retailer/merchant side, to implement the method according to an embodiment of the present invention. In alternative exemplary embodiments of the present invention, the transaction data access and receipt regeneration process can occur at other points in the transaction data transmission pathway, including at the POS terminal, or at an intermediate processing while still in the inter-bank network (e.g., ETSL or EftPOS in the illustrative example), as economics and resource allocation may determine in various commercial cultures and contexts.

The following exemplary pseudocode illustrates an exemplary implementation to select receipt data and create a receipt according to an embodiment of the invention as in 302 and 303 in FIG. 3. Such pseudocode could be implemented in any high-level programming language known or to be known in the art, such as for example, Assembler, C/C++, COBOL, or PL1. Using a program implementing the following pseudocode to create and print an exemplary receipt, a receipt having the format and field placement such as is depicted in FIG. 6 will result (the actual values in the various fields will depend on the actual POS data accessed).

; Title: Eft-POS Recreation Application
; Format: Pseudo-code
; Purpose: To recreate the Original Eft-POS Receipt
; such that the receipt is acceptable
; as proof of purchase.
; Defs
PH = Eft_POS_Header(20)
M1 = Merchant_Address_Line_1(20)
M2 = Merchant_Address_Line_2(20)
M3 = Merchant_Address_Line_3(20)
M4 = Merchant_Details_Line_4(20) ;only present if cash not taken out
MID = Merchant_Identifier(11)
PID = Eft_POS_Terminal_Identifier(8)
D = Date(6)
T = Time(5)
TR = Transaction(6) ;if present - may have been stripped off at
inter-bank exchange
AT = Account_Type(5)
EA = Encrypted_Account_Details(16)
CT = Currency(4)
P = Purchase_Amount(8)
CA = Cash_Amount(8) ;may not be present
TA = Total_Amount(8)
AUC = Authorization_Code(2)
AUD = Authorization_Description(9)
PT = Eft_POS_Trailer(20)
CAN = Customer_Account_Number(15) ;from magnetic swipe card
C = CheckSum(2)
E1 = PH + M1 + M2 + M3 + M4 + MID + PID
E2 = D + T + TR + AT + EA + CT + P + CA + TA
E3 = AUC + AUD + PT + CAN + C
Eft_Transaction_Data = E1 + E2 + E3
; At COLD/OARS Access Point
LOOP

Identify Customer Number in Data Stream ;Format = CAN
Extract Print_Stream ;Existing COLD/OARS Data Extraction
Extract EFT_Transaction_Data ;Existing Data - Not currently
extracted
Goto Create_Original_Receipt
Attach to Print_Stream ;In COLD/OARS Archive by Customer#

UNTIL (No more CAN)
; Create Original Receipt
Create_ASCII_Record

IF NOT PH THEN Insert “*------EFTPOS------*”

ELSE Extract PH

ENDIF
Insert <CR>
Extract M1
Insert <CR>
Extract M2
Insert <CR>
Extract M3
Insert <CR>
IF M4 THEN

Extract M4
Insert <CR>

ENDIF
Insert “MERCHANT”
Extract MID
Insert <CR>
Insert “TERMINAL”
Extract PID
Insert <CR>
Insert “TIME”
Extract D
Insert “ ”
Extract T
Insert <CR>
Insert “TRAN”
Extract TR
Extract AT
Insert <CR>
Extract EA
Insert <CR>
Insert “PURCHASE”
Extract CT
Extract P
Insert <CR>
IF CA THEN

Insert “CASH”
Extract CT
Extract CA

ENDIF
Insert <CR>
Insert “TOTAL”
Extract CT
Extract TA
Insert <CR>
Insert “(”
Extract AUC
Insert “)”
Extract AUD
Insert <CR>
IF NOT PT THEN Insert “*_{——————}*”

ELSE Extract PT

ENDIF

FIG. 6 is an exemplary receipt according to the present invention constructed to track the details of the illustrative example discussed hereinabove created by following, for example, the guidelines of the pseudocode described above. As can be seen, it contains 14 lines of 20 characters each, which in a text-based format such as ASCII occupies 280 bytes, one byte of data being associated with each ASCII character. As can further be seen, there are various fields in the exemplary receipt, some or all of which may be used in various other embodiments of the invention depending upon local business customs and local requirements for the purposes of proving a transaction to merchants, to credit card/debit card companies, or to applicable taxing authorities.

With respect to FIG. 6, the following information may be contained in the receipt. On the first line 601 there is the designator “EFTPOS,” which refers to the exemplary banking network utilized to transmit the transaction details from the POS terminal to the customer's bank according to an embodiment of the present invention. On the second through fourth lines appear information which identifies, for example, the merchant by particular store 602, by particular street that particular store is located in 603, and by the city that particular store is located in 604. The fifth line 605 is blank in this exemplary receipt. Line 606 has the designator “MERCHANT” and a unique merchant number, line 607 has the designator “TERMINAL” and a unique terminal number (referring to the POS terminal which facilitated the transaction), line 608 has a “TIME” designator and provides the date in the international format of DD/3 letter Month Abbreviation/YY, or in another appropriate format in the United States, and the transaction time using the 24 hour convention.

Line 609 has the designator “TRAN” which stands for transaction and has a unique transaction identifier and also has the type of account which is the source of the electronic payment. As is known in the art, the data to be captured from the POS transaction data to generate the receipt can be readily identified since the POS transaction data uses known formatting protocols. In this exemplary receipt, it is the customer's savings account. The tenth line 610 contains the savings account number, although it could alternatively contain a credit card account number to which the purchase would be charged. The eleventh line 611 contains the amount of the purchase, and the twelfth line 612 contains the total amount debited or credited after adding any cash advance (generally referred to as “cash back”) at the time of the transaction. The thirteenth line 613 contains the code which is associated with the fact that the transaction was accepted and the word “ACCEPTED”, and the fourteenth and final line contains a footer indicating the termination of the POS receipt.

The receipt generated at 303 is sent to, for example, an electronic archiving system where, at 304, it is sent to an electronic archive for storage, which is completed at 305 where the receipt is stored in an indexed data structure as is or may be known in the art. In an exemplary embodiment of the present invention, the data structure will be indexed, inter alia, by a customer number assigned to each customer by the system (generally the customer number assigned to the customer by its card issuing bank), facilitating its retrieval by a customer subsequently accessing the system.

An advantage provided by the present invention is the fact that the receipt is electronically regenerated in text format, as opposed to the much more cumbersome image formats used in conventional receipt capturing and storage systems. Thus, in an exemplary embodiment of the present invention, the information for the auto-receipt is stored within the transaction details that are sent across the inter-bank provider network. Upon reaching the partner bank, the electronic receipt is thus recreated in ASCII format, and sent in that format, to the electronic archive.

A simple comparison of file size illustrates the value of using a text-based format according to an embodiment of the present invention, such as ASCII, as opposed to an image format. For example, a comparison can be made using an exemplary electronic receipt such as is shown in FIG. 6. The receipt depicted in FIG. 6 corresponds to the illustrative example used herein, involving the customer at the retail outlet coffee shop. As can be seen in FIG. 6, the receipt includes, for example, fourteen lines of twenty characters each, which requires, using ASCII text, 280 bytes of data storage. Additional account details and any desired type of index header also can be added (such as depicted in the example system of FIG. 2). Accordingly, the total data storage overhead for the electronic receipt according to this exemplary embodiment of the present invention is approximately 320 bytes. Contrasting this approximate 320 bytes with the same receipt depicted in FIG. 6 stored as a .GIF file (12 Kb) or a .JPG file (11 Kb), illustrates the tremendous data storage capacity savings achieved by regenerating and storing the electronic receipt in a text format (an approximately 1:30 ratio) in accordance with an embodiment of the present invention. Moreover, the .GIF and .JPG formats are compressed formats, as is well known in the art. Storing the exemplary receipt depicted in FIG. 6 as a non-compressed image file, such as a .TIF (101 Kb) or a .BMP (101 Kb) file, further adds an additional ten-fold size requirement on the data transmission and data storage systems.

Generating the electronic receipt in, for example ASCII, allows the receipt to be transmitted very quickly, even across communications networks utilizing standard PSTN lines and a dial-up modem. Further, the text-based format, inasmuch as it is completely regenerated from the electronic ASCII codes, is the clearest and most exact representation of any format. This is because digitized image files, of necessity, divide the scanned image into a certain fixed number of pixels. This requires, even in binary image formats, quantization and round off errors. These errors are often visible in the printed image as blurriness or artifacts.

In the discussion thus far, the exemplary POS receipt has been followed from its creation to its storage and indexing within a data structure, culminating at 305 with reference to FIG. 3. What will next be discussed is the functionality for accessing a receipt by a customer.

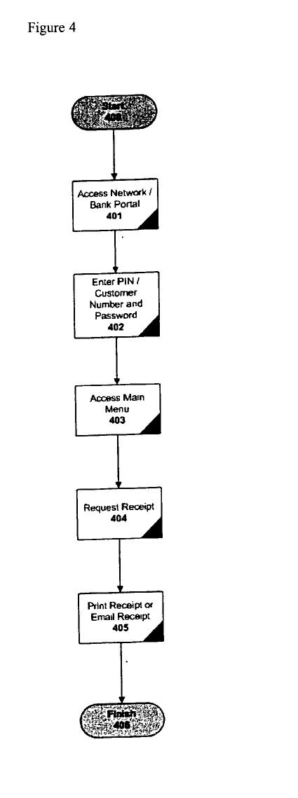

FIG. 4 depicts the process flow for a customer accessing and obtaining either an electronic or a hard copy of the receipt. At 401, a customer accesses a portal to a data network which is interconnected to a receipt archive. This is commonly done via a automated teller machine (ATM), via an in-person request to a bank teller, or via an on-line request at a web site of the customer's card issuing bank. This functionality corresponds to s 227, 228 and 229 in the example system of FIG. 2.

The receipt archive can be maintained by the system operator, by the customer's bank, by an inter-bank network, or the like, as market conditions, business relations and efficiencies may dictate. In an example embodiment the receipt archive is maintained by an archiving company that provides various database and archiving services to the customer's bank. Thus, in such an example embodiment, the POS data is sent to the customer bank via an inter-bank network, the bank extracts the transaction details, regenerates the receipt, and sends it to the archiving company for storage.

Returning to 401, once a given network portal has been accessed the customer is prompted by the system to enter a unique Personal Identification Number (PIN) to access his or her receipt record maintained by the system. At 403, upon entry of a valid PIN the system displays a main menu, which in the case of an ATM contains various functions commonly used at such devices. In the case of an online banking web page this menu may contain additional functionalities as are known in the art. In either alternative, at 404 the customer is presented with a request receipt menu at which the customer can proceed to 405, having selected a particular receipt or receipts, and either print the receipt or have the receipt mailed to an email account of his or her choice. As well, in non ATM contexts, the customer may also have the option of storing the receipt on his or her local device.

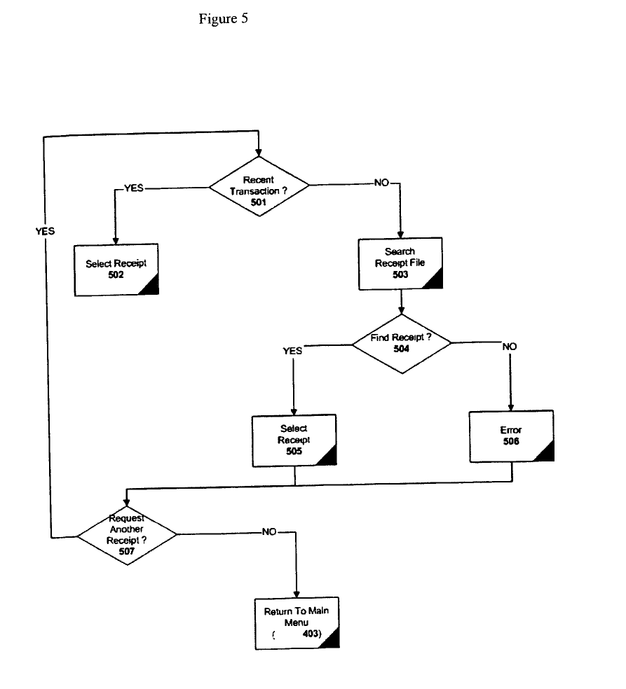

FIG. 5 depicts a lower level, more detailed flow chart for 404 of FIG. 4. With reference to FIG. 5, the customer is first prompted, at 501, as to whether the requested receipt is associated with a recent transaction or not. In an exemplary embodiment the system may consider three months to be the time period during which receipts are considered recent and three months worth of receipts are thus continually available without any further search any time a customer accesses 404 of FIG. 4 and requests a receipt. In other exemplary embodiments of the invention, depending upon the volume of receipts and available storage capacity in local bank network portals, this time frame may be varied. If the receipt is associated with a recent transaction the process flow moves to 502 and the customer selects the desired receipt from the listing, in an exemplary embodiment this would be a chronological listing, of the recent receipts.

If the receipt is not associated with a recent transaction the process flow moves to 503 and the customer is prompted to initiate a search of his or her receipt file for the desired receipt. This can be done, for example, by merchant, by date, by range of dates or any other convenient search criteria as may be known in the art. Once the results of the search are completed, the process flow moves to 504 and the customer is prompted to indicate whether the desired receipt has been located. If so, the process flow moves to 505, and that receipt is selected. If not, because for example either the customer cannot provide enough information to allow the search to return an accurate result, or perhaps the customer is mistaken as to what transactions he or she engaged in, an error message is returned at 506. If the searched for receipt has been found and selected at 505, process flow moves to 507 and the customer is prompted whether another receipt is desired. If the answer is yes, the process flow then returns to 501 and the process is repeated. If the answer is no, then process flow moves to 508 and the customer is taken back to the main menu, i.e. 403, in the example of FIG. 4. As well, if at 506 an error message has been returned because the customer's desired receipt could not be found, the process flow also moves to 508, and the customer is returned to the main menu.

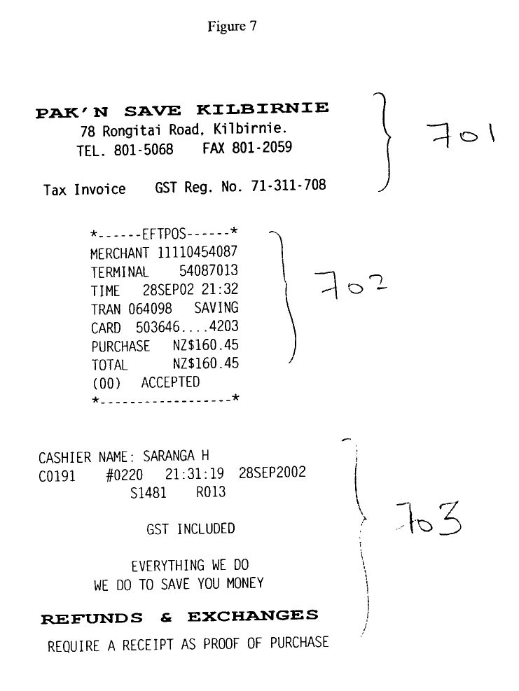

FIG. 7 depicts an alternative exemplary receipt according to an embodiment of the present invention that could be used in selected markets, if desired. The exemplary receipt of FIG. 7 is divided into, for example, three distinct areas. A header 701, a central area 702 containing the information presented in the exemplary receipt of FIG. 6 in abbreviated form, and a footer 703. In the exemplary receipt of FIG. 7, the POS data has been reduced to, for example, ten lines of twenty characters each. In addition to the POS transaction data 702, there is a header 701 containing the merchant name, address, telephone number and fax number. The merchant name and address are transmitted as part of the POS transaction details, and thus they appear in the exemplary receipt of FIG. 6, at lines 602-604. Nonetheless, in the exemplary receipt of FIG. 7, this information is presented in a header 701, and thus does not need to be included in the POS transaction data 702 section of the exemplary receipt. The use of the header 701 allows, for example, the merchant information to be embellished by adding a merchant telephone number and fax number, and to present the information in a desired font with desired spacing, etc. for marketing/branding purposes.

As well, a footer 703 with a cashier's name and certain merchant specific codes, as well as a slogan or other branding information, and a store return policy statement are also presented in this exemplary receipt. Such slogans and other information are not generally sent as part of the POS transaction data. Thus, to recreate this type of exemplary receipt, the exemplary pseudocode presented above would need slight modifications, as is understood by those skilled in the art. Such modifications would include, for example, a look up table indexed, for example, by the merchant number, to allow an exemplary receipt generated therewith to display the merchant specific header and footer used in the type of exemplary receipt depicted in FIG. 7. In order to reproduce the example merchant specific information in the exemplary receipt of FIG. 7 (e.g., the cashier's name and the two fields on the line underneath the cashier's name) which are not transmitted as POS data by the merchant's POS terminal, it would be required to interface with and access the merchant's computer, and extract this data by searching the merchant's stored transactions using the transaction number or the terminal number and the date and time. Even if such interfacing is not implemented, a receipt identical to the exemplary receipt of FIG. 7, except for the lack of the cashier's name and the two merchant specific fields displayed on the line underneath the cashier's name, is understood to be legally sufficient as proof of purchase, and thus such lack is not understood to be critical to the function of a POS receipt generated in accordance with an exemplary embodiment of the present invention.

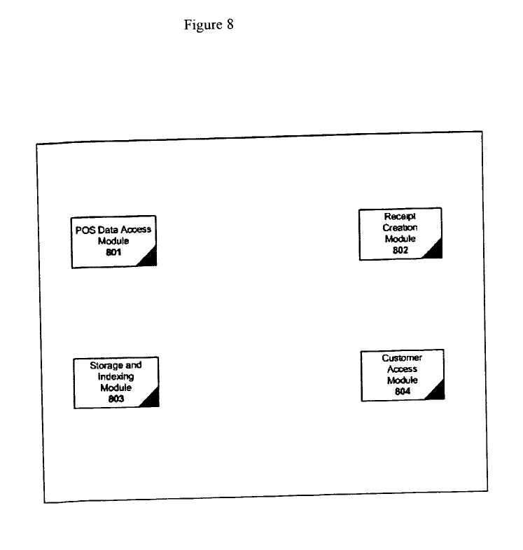

FIG. 8 depicts an exemplary modular software program of instructions which may be executed by an appropriate data processor, as is known in the art, to implement an exemplary embodiment of the present invention. The exemplary software program may be stored, for example, on a hard drive, flash memory, memory stick, optical storage medium, or other data storage devices as are known or may be known in the art. When the program is accessed by the CPU of an appropriate data processor and run, it performs, according to an exemplary embodiment of the present invention, a method for generating and maintaining an electronic receipt for a transaction involving electronic payment. The exemplary software program has four modules, corresponding to four functionalities associated with an exemplary embodiment of the present invention.

The first module is, for example, a POS Data Access Module 801, which can access a POS data stream, as described above. A second module is, for example, a Receipt Creation Module 802, which, using a high level language software implementation of the pseudocode described above, extracts relevant data from the POS data stream and generates a receipt according to an exemplary embodiment of the present invention. A third module is, for example, a Storage and Indexing Module 803, which stores a receipt generated by the Receipt Creation Module in an indexed manner in a memory to facilitate easy access. A fourth module is, for example, a Customer Access Module 804, which via a user interface as is known or may be known in the art, facilitates a customer of a bank to search for and request one or more receipts as created and stored by, for example, modules 802 and 803, and fetches the requested receipt or receipts and delivers it or them to the customer, for example, through an existing ATM machine.

Modifications and substitutions by one of ordinary skill in the art are considered to be within the scope of the present invention which is not to be limited except by the claims which follow.

What is claimed is:

1. A method of generating and maintaining an electronic receipt for a transaction, comprising:
accessing electronic point of sale transaction data;
generating a receipt in a text format from the transaction data;
storing the generated receipt in an indexed database; and
making the receipt accessible to a customer via one or more on-line electronic communications networks.

2. The method of claim 1, where the text format is ASCII.

3. The method of claim 1, where the indexed database is indexed by a customer number.

4. The method of claim 1 where the on-line electronic communications networks include one or more of an ATM network, the Internet, a private intranet.

5. The method of claim 1, where the point of sale transaction data is accessed after its transmission to a data network by a merchant.

6. The method of claim 1, where the receipt contains a merchant address, a merchant identifier, a POS terminal identifier, a date and time of sale, a transaction identifier, a purchaser bank account type and number, a purchase amount, and a total debit or charge amount.

7. The method of claim 1, where accessing the transaction details and generation of the receipt occur at the electronic funds transfer system associated with the purchaser's bank card.

8. The method of claim 7, where said accessing and regeneration are accomplished during periodic updates of customer accounts in a back office of the bank.

9. A computer program product comprising:
a computer usable medium having computer readable program code means embodied therein, the computer readable program code means in said computer program product comprising means for causing a computer to:
access electronic point of sale transaction data;
generate a receipt in text format from said transaction data;
store the generated receipt in an indexed database; and
make the receipt accessible to a customer via one or more on-line electronic communications networks.

10. The program product of claim 9, where the text format is ASCII.

11. The program product of claim 9, where the indexed database is indexed by a customer number.

12. The program product of claim 9, where said one or more electronic communications networks include one or more of an ATM network, the Internet, and a private intranet.

13. The program product of claim 9, where the accessing of transaction details and regeneration of the receipt are accomplished at the transaction's purchaser's bank.

14. The program product of claim 13, where said accessing and regeneration are accomplished during periodic updates of customer accounts in a back office of the bank.

15. A program storage device readable by a machine, tangibly embodying a program of instructions executable by the machine to perform a method for generating and maintaining an electronic receipt for a transaction, said method comprising:
accessing electronic point of sale transaction details;
regenerating a receipt in text format from said transaction details;
storing the regenerated receipt in an indexed database; and
making the receipt accessible to a customer via one or more on-line electronic communications networks.

16. The program storage device of claim 15, where the text format is ASCII.

17. The program storage device of claim 15, where the indexed database is indexed by a customer number.

18. The program storage device of claim 15, where said one or more on-line electronic communications networks include one or more of an ATM network, the Internet, and a private intranet.

19. The program storage device of claim 15, where the accessing of transaction details and regeneration of the receipt are accomplished at the transaction's purchaser's bank.

20. A system for generating, maintaining and providing an electronic receipt for a transaction where electronic payment was used, comprising:
a POS terminal;
a first data network;
a financial institution;
a second data network;
a receipt processor connected to the second data network;
an archiving system; and
one or more third data networks; and
where the POS terminal transmits transaction data via the first data network to the financial institution, the financial institution transmits the transaction data to the archiving system via the second data network, the receipt processor accesses the transaction data from the second data network and generates an electronic receipt, and a user accesses the electronic receipt via a third data network.

21. The system of claim 20, further comprising portals to the one or more third data networks, including one or more of an ATM machine, a PC, a cell phone and a PDA.
